(19) United States
(12) Patent Application Publication
(10) Pub. No.: US 2007/0168905 A1
(43) Pub. Date: Jul. 19, 2007

(54) Networked linux machine and windows software development system

(76) Inventors: John Bromley, Escondido, CA (US); Abe Iskac, Escondido, CA (US); Jonathan Lipsher, San Diego, CA (US)

Correspondence Address: JACKSON WALKER LLP, 901 MAIN STREET, SUITE 6000, DALLAS, TX, 75202-3797, US

(21) Appl. No.: 11/343,046

(22) Filed: Jan. 30, 2006

Related U.S. Application Data
(60) Provisional application No. 60/734,585, filed on Nov. 8, 2005.

(51) Int. Cl. G06F 9/44

(52) U.S. Cl. 717/100

(57) ABSTRACT

An ARM Development Environment (ADE) PCBA and platform. The ADE platform advantageously allows software development for processors, including the current ARM9 processor and its peripherals on a stable, well-known piece of hardware. A wide range of product types can be assembled from subsets of the features of the present invention. The invention allows engineers to experiment with system architecture, user interface, and software development while product-specific hardware and mechanical assemblies are being produced.

### CLAIM OF PRIORITY

This application claims priority of U.S. Provisional Application Ser. No. 60/734,585 entitled “Converged Device Companion Connecting an External Viewing Platform to a Handheld Device” filed Nov. 8, 2005.

### FIELD OF THE INVENTION

The present invention relates to software development systems.

### BACKGROUND OF THE INVENTION

Software applications are typically developed by software developers by developing source codes and compiling them into binary files. Typically, the development of the source codes and the compiling of same is performed on a single machine, such as on a Windows based system, or a Linux Machine. Both the Windows based system and Linux Machine each have respective advantages. Windows based systems have very productive Windows utilities, such as Visual Editor, Windows Search, and Find Tools. Linux Machines find advantages in that they allow sharing of toolchains, when a Windows PC development system does not.

There is desired a software development system that takes advantage of the features of different software development systems, and which also allows engineers and developers to experiment with system architecture, user interface, and software development which product-specific hardware and mechanical assemblies are being produced.

### SUMMARY OF INVENTION

The present invention achieves technical advantages as an ARM Development Environment (ADE) PCBA and platform. The ADE platform allows software development for the processors, including the current ARM9 processor and its peripherals on a stable, well-known piece of hardware. A wide range of product types can be assembled from subsets of the features of the present invention. The invention allows engineers to experiment with system architecture, user interface, and software development while product-specific hardware and mechanical assemblies are being produced.

### BRIEF DESCRIPTION OF THE DRAWINGS

FIG. 1 is a block diagram of an ARM development environment (ADE) PCBA and platform according to one embodiment of the present invention;

FIG. 2 depicts a project directory structure;

FIG. 3 depicts a communication method and network protocol;

FIG. 4 depicts software modules and their sequences of invocation;

FIG. 5 depicts low-level hardware initialization process in more detail; and

FIG. 6 illustrates the flow and steps for loading the operating system prior to executing an user application.

### DETAILED DESCRIPTION OF THE PRESENT INVENTION

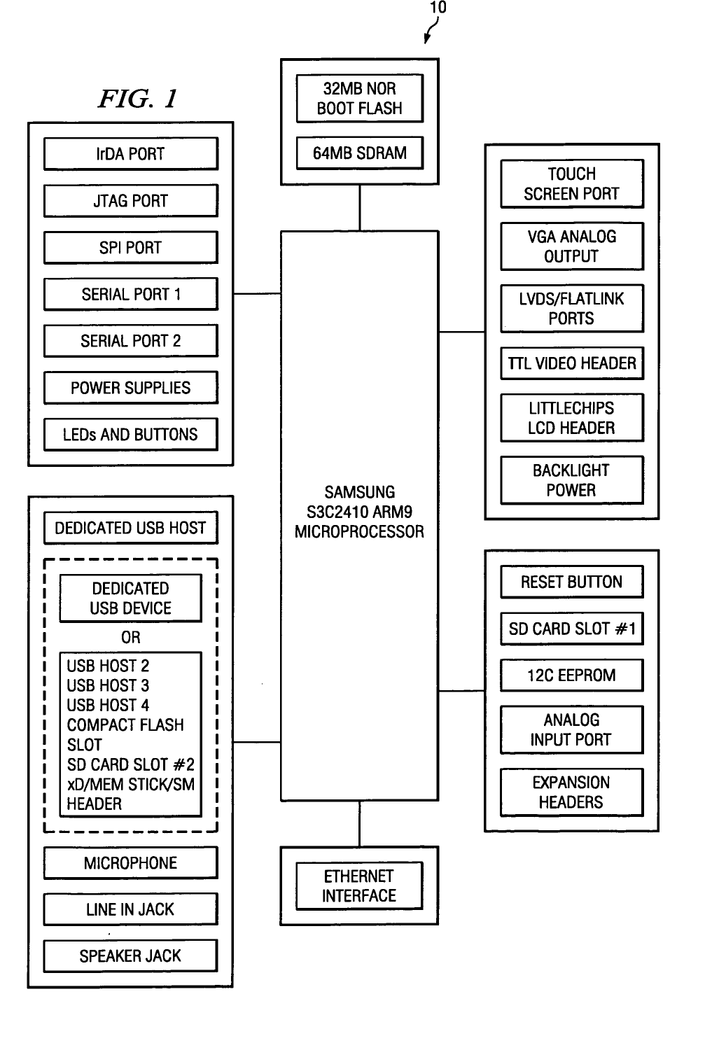

According to one preferred embodiment of the invention shown at 10 in FIG. 1, due to its rich feature set, peripheral architecture, and inexpensive price-point, the Samsung S3C2410A processor may be used as the engine on an ADE PCBA and platform. The range of features present in this system allows engineers to create products as complex as today's mid to upper-level Personal Digital Assistants. (PDAs).

The S3C2410A processor is based upon an ARM9 core. It includes various on-chip peripherals, and several industry standard busses which are used to interface with off-chip memory and peripherals. In the present system, the '2410 is run at its maximum internal clock rate of 266 MHz. This internal clock is generated by a PLL in conjunction with an external 12 MHz crystal oscillator circuit. The '2410 includes an on-chip Real Time Clock circuit which runs on its own 32.768 kHz crystal and is optionally backed up by a 1F supercap to supply power for a limited time when external power supplies are not present. (INVENTORS SHOULD WE INCLUDE ALL SCHEMATICS?)

Power Rails

The '2410 uses a 3.3V power input to source its external I/O buffers and as a reference for its internal A/D conversion. For the internal logic, a 1.8V rail is supplied. In order to ensure that the processor is not asked to do anything before both power rails have stabilized, a simple RC timer circuit is placed on the processor's nReset line. To prevent a metastable state on the clock input, this RC circuit's output is routed through two inverter devices on its way to the processor input pin.

External Interrupt Sources

The '2410 provides up to 24 external interrupt sources. Some of these pins have instead been used to implement General Purpose I/O (GPIO) pins. Here is the connection table for each of the interrupt pins:

| | | |
|---|---|---|
| EINT0: | SD_IRQ | Interrupt signal from ‘2410’s |
| | | peripheral SD Card slot |
| EINT1: | nButton1 | Active low signal from |
| | | the board's pushbutton #1 |
| EINT3: | IRQ_LAN | Interrupt signal from the |
| | | board's Ethernet controller |
| EINT4: | nLED1 | GPIO output to LED #1 |
| EINT5: | nLED2 | GPIO output to LED #2 |
| EINT6: | nLED6 | GPIO output to LED #3 |
| EINT7: | nLED7 | GPIO output to LED #4 |
| EINT8: | nButton2 | Active low signal from the |
| | | board's pushbutton #2 |
| EINT9: | nButton3 | Active low signal from the |
| | | board's pushbutton #3 |
| EINT16: | GPIO1 | GPIO pin brought out to |
| | | the expansion header |
| EINT17: | GPIO2 | GPIO pin brought out to |
| | | the expansion header |
| EINT18: | GPIO3 | GPIO pin brought out to |
| | | the expansion header |
| EINT19: | nButton4 | Active low signal from the |
| | | board's pushbutton #4 |

The '2410's remaining External Interrupt pins are used to implement various peripheral busses detailed below.

A/D Converter

The '2410 includes an 8-channel analog to digital converter. All but two of these channels are unassigned and routed to the board's expansion header for future use. The two inputs which are used are there to implement a touch-screen interface. The LCD module includes a touch-screen interface which can be monitored via the processor's AIN5 and AIN7 pins. It should be noted that the implementation of the touch-screen interface forced us to set the conversion reference voltage to 3.3V. All incoming signals will thus be compared with this 3.3V when the processor determines their digital representations.

SD Card Controller

The '2410 includes a Secure Data (SD) Card controller. This controller's pins are connected on the ADE board to an SD-Card slot connector. It should be noted that this controller is capable of supporting 4-bit wide transfers from SD cards—should they be able to offer this connectivity.

DMA

The '2410 offers DMA to external peripherals, temporarily relinquishing control of the memory bus to peripherals wishing to make high speed burst transfers to/from system memory. This feature is unused on the ADE board, however, the DMA signals are brought out to the board's expansion header.

Memory

The ARM9 processor is based on a 32-bit wide memory bus with 128 MB (26 address bits) in each of 8 memory banks. Banks are selected via signals nGCS0 . . . nGCS7. Bank 0 is the boot ROM bank which is responsible for holding the code that is first run by the processor after power has been applied. The on-board boot ROM is a 16 b-wide, 16 MB NOR Flash part from Intel. The NOR Flash is fast enough to support execute-in-place (XIP) operation—so the '2410 can run instructions directly from ROM without first copying them to faster SDRAM. Jumper JP3 on the ADE board allows the operator to switch between the on-board 16 b NOR flash and an 8 b NAND flash device for the boot ROM. If the user selects a NAND flash boot device, then he/she is expected to place such a device on the memory bus pins of the expansion header.

Memory bank 6 is used for the system's SDRAM. This 32 b-wide bank is made up of two 16 b-wide, 32 MB Samsung SDRAM parts (for a total of 64 MB) connected to both the '2410's memory bus and to the SDRAM controller pins.

Memory bank 1 is used as a channel to speak with the board's Ethernet controller chip—a CS8900A chip from Cirrus Logic.

The remaining memory banks are unused on the ADE board. However, the control signals for these banks have been brought out to the expansion header for future use.

USB (and Flash Card Reader)

The '2410 includes 2 USB 1.1 host ports—one of which can be reassigned as a device port. The ADE system has a dedicated host port (J3) connected directly to the '2410. This port will have unshared access to the full bandwidth of a USB 1.1 port—about 12 Mbps. The 2^{nd} USB port can be configured in one of many ways via jumpers. Jumpers JP6 and JP7, will determine whether the 2^{nd} USB port is selected to be a host or device port. If the 2^{nd} port is set to be a host, then this port is routed through a hub chip which branches out to 4 host ports (which share the USB 1.1 pipe into the processor). The 4^{th} host port out of the hub chip is jumper selectable to be routed to a 4^{th} host connector or a Multi-Format Memory Card Reader/Writer. This selection is made via jumpers JP4 and JP5. This memory card interface IC provides ports to SD, MMC, SM, XD, CF, and MS (Memory Stick) media. All of the memory card IC's port signals have been routed to an expansion header. Additionally, the chip's SD and CF card port signals have been wired to an SD card slot and CF slot, respectively. If the 2^{nd} port out of the '2410 is jumper-set to be a USB device port, then it is important to note that one of the processor's GPIO pins has been routed to allow firmware control over the “presence” pulldown on the D+ line of the device port. This connection will allow the processor to boot completely before announcing its presence as a device to any connected USB host. This will also force the USB device connection to be reset whenever the processor is reset—even if the board power is not cycled.

SPI

The '2410 includes a pair of SPI ports for interfacing with various peripheral devices. These ports are not used on the ADE system. However, the control signals for these busses have been routed to an expansion port for future use.

I²C (Serial EEPROM)

The '2410 includes an I²C host port. This port's signals have been routed to both the expansion header and a small serial EEPROM device.

I²S (Audio)

The '2410 includes an I²S port for communication of raw audio sample data to and from an AC'97-compatible codec. On the ADE board, these signals have been routed to a codec. This codec is connected to a speaker jack (for connection to headphones or an amplified speaker system), an on-board microphone for voice or live music recording, and a line-input jack for recording directly from an analog source. In addition to the I²S bus, three of the '2410's GPIO pins have been devoted to the implementation of an L3 bus. This bus is responsible for sending control information—such as volume and tonal settings—to the codec.

JTAG

The '2410 includes a JTAG port for convenient programming and debugging. The ADE system routes the JTAG pins to a header.

UARTs (and IrDA)

The '2410 includes 3 UART ports for use in forming asynchronous serial connections with external computing machinery. In the ADE system, two of these ports have been routed through level-shifting ICs (to create RS232 signal levels) to standard DB9 connectors. Of these two, the port routed to connector J2 includes support for hardware flow control via RTS and CTS pins. The 3^{rd} UART from the '2410 is routed to an IrDA transceiver module for infrared communication.

VIDEO (and Touch-Screen Interface)

The '2410 includes an embedded LCD controller for automatically driving video data out of a programmable section of system memory (designated to be the frame buffer). This LCD controller's outputs take the form of several video control (synchronization) signals, and a 24-bit pixel data bus. Our ADE system buffers all of the video signals with level translator chips. This allows the user to select either a 3.3V or 5V rail when interfacing with an LCD (as dictated by the particular model of LCD). Video data is output from the ADE board via the following methods:
1. A generic header which carries all of the digital video data and control signals as well as both supply rails is present to interface with various models of LCD.
2. A DB15 connector carries analog signals representing the red, green, and blue video data and the synchronization signals is present. This connector provides a connection point for an external monitor or video projector. The analog video signals are generated by a triple video D/A converter chip.
3. 3-channel (plus a differential clock) serialized LVDS video data and control lines are provided to drive a larger-format LCD. These signals are brought to both a standard 0.1″ pin header and a special flat connector—which mates with a display which was used in certain laptop computers.

The interface to the touch-screen requires 4 GPIO pins and 2 analog input pins from the '2410. Manipulating the GPIO pins feeds the touch-screen column and row voltages. Monitoring the analog voltages fed back from the touch-screen, the processor can compute the location of an object coming into contact with the screen.

Other ADE System Features Not Covered Above

DIP Switches

The ADE board includes a bank of 6 DIP switches which have been connected to GPIO pins on the '2410.

Board Reset

The ADE board can be reset via a pushbutton. This pushbutton is debounced by the same RC circuit which provides the initial powerup delay to the processor. The processor buffers the reset input line to an output signal which is inverted and then routed to the Ethernet interface chip. In this way, pressing the reset pushbutton should reset the main processor, the USB device connection, and the Ethernet connection.

Board Power

The ADE board should be powered by a regulated power supply or “wall wart” capable of providing 5V at a minimum of 2A. The barrel connector used for the power input to this board expects an input power connector with a grounded sleeve and an I.D. of 2 mm and O.D. of 5.5 mm

Beyond the input power connector, there is a power on/off toggle switch, a power-on indicator LED, and a resetable fuse device. The 5V input is used to directly power the USB Vbus and potentially the LCD interface signals. The input power is also used to supply the board's dual-output switching regulator. This switcher generates both the 3.3V and 1.8V rails used throughout the board.

Firmware—Software Design

This section describes the steps taken for setting up the ARM9 development board and for developing and running an application program under Linux Kernel version 2.6.13.2.

Software Development Environment

To start with a software development for a project, based on an embedded Linux platform, a whole new development environment has to be established.

The goal of setting up this environment was low-cost, flexibility, robustness of toolchain, and high-level of productivity.

Since GNU based toolchain will be used, the cost was cut to zero. A Linux server running on a laptop was put together and used to host the cross-development toolchain.

To achieve high-level of productivity, most of the Windows PC software tools, such as visual editor, search and file compare utilities, etc. are fully utilized and properly setup to work with the Linux server in an efficient, localized network environment.

Board Bootloader

When an ARM9 microprocessor is powered on, it will assert its CS0 signal, and puts out all zeros on its address lines. In response to this condition, the Flash device will supply the initial instruction word on the processor data bus. This reset exception will cause the microprocessor to execute the program sequences stored in the Flash chip, starting from a known state.

An initial bootup sequence is usually associated with setting up the Chip Select signals and configuring the external memory controller, allowing an actual firmware to be run with full access to read/write memory. In our development board, this read/write memory is implemented as a 64 MBytes SDRAM module.

This is accomplished by a low-level, primitive board initialization program, called bootloader. At the completion of the process of booting the board, the bootloader will invoke/call a more sophisticated debugger, called U-Boot.

The first step in bringing up the hardware involves placing the binary image file called “LN2410SBC_bootloader.bin” into the boot partition of the Flash chip.

In the initial development board, this process can be done on the target board itself with the help of a simple JTAG Interface Module. A Flash application program running on a host PC will take control of the target ARM9 microprocessor externally, through its JTAG interface.

A sequence of low-level read and write memory accesses will then be invoked by the microprocessor under a PC control, which in turn causes the whole bootloader binary files to be burned into the Flash chip.

In our newly designed hardware platform, the above process currently has to be done external to the board, on a Flash programmer.

The next step in the firmware setup process is the placement of a U-Boot debugger code, which will be invoked by the bootloader upon poweron or reset of the microprocessor.

U-Boot Debugger

The U-Boot Debugger is burned into the Flash chip starting at an offset address of 0x10000. This absolute starting address of U-Boot is dictated by the previously discussed bootloader module, which will try to execute a program starting at the above address.

U-Boot 1.0 for ARM9 is a public domain debugger, which has been customized to support Samsung ARM9 core microprocessor. The source and patch codes are built with additional command features to support hardware and software development stages.

Commands such as SDIO test, and LCD test are added to U-Boot to support the hardware and software development.

GNU GCC version 2.95.3 is used to build U-Boot binary file. The following steps are used to generate a binary file called ‘u-boot.bin’::

# cd ˜/work/U-Boot/uboot_mobl
# make ln2410sbc_config
# make clean
# make

When the build process completes successfully (no errors reported), the uboot.bin file is ready to be burned into the Flash chip, starting at an offset address of 0x10000.

With the bootloader and U-Boot firmware modules programmed into the Flash chip, a poweron or manual reset to the processor brings up an interactive command interface on the main UART0 serial port for the user to operate the development platform.

One of the reasons for bringing up the development board with U-Boot Debugger is its rich command list.

In addition to supporting basic commands such as ‘memory display, memory read/write’, etc., U-Boot implements file transfer support over the ethernet interface, which is very important for software development.

Using TFTP file transfer protocol, higher level codes and usually larger binary files can be downloaded from the host development machine (Linux Server) to the development board at 10 Mbits/sec.

The Linux Kernel image of approximately 3 Mbytes is constantly developed and downloaded for testing on the board using this method. The following U-Boot command is used for this purpose:

# tftp 32000000 bootpImage
# go 32000000

The above U-Boot command initiates a request to the TFTP Server (running on a Windows PC) to open and read a file with the filename ‘bootpImage’, and perform a file transfer using a TFTP protocol with the development board.

On the development platform side, the received file is placed in memory starting at location 0x32000000. TFTP Client is run on the development board for this purpose.

The subsequent ‘go’ command is used to execute the downloaded kernel image.

Building Linux Kernel 2.6.13.2

The kernel file ‘bootpImage’ mentioned in the previous section contains a composite binary image of the Linux kernel 2.6.13.2 and the associated, required ramdisk filesystem.

The generic ARM C compiler attribute for this toolchain (2.95.3) was ‘arm-linux-xxx’. The following example will compile a test.c file into an executable file called ‘test’:
# arm-linux-gcc -o test test.c;arm gcc 2.95.3

A decision to switch to Linux kernel version 2.6.13.2 was made after an investigation revealed that more device supports are and will be available for this latest version. One example is the support for a Secured Digital (SD) Interface, as well as the video frame buffer device driver.

Along with the new kernel was the required GCC Cross Compiler Toolchain version 3.4.3. The generic ARM C compiler attribute for this GCC release is ‘arm-none-linux-gnueabi-xxx’. The following example will compile a test1.c file into an executable file called ‘test1’:
# arm-none-linux-gnueabi-gcc -o test1 test1.c;arm gcc 3.4.3

In the build process of the latest kernel, it was discovered that starting from GCC Release 3.x.y, an attempt was made for the generated binary file to conform to the ABI (Application Binary Interface) specification.

This has caused some complications when trying to build an application program using GCC 3.4.3 toolchain. As a sidenote, at this point an application program has to be built with GCC 2.95.3 to be executable within the new kernel 2.6.13 environment.

The following sections describe preferred steps to build the Linux kernel binary, that can then be downloaded and executed successfully on the development board:

1. Install cross toolchain

Download prebuilt gcc 3.4.3 from CodeSourcery (2005Q1B version)
Install them to /usr/local/arm/release-3.4.3
Set path and environment variables:
# ORIGINAL_PATH=$PATH
# export PATH=/usr/local/arm/release-3.4.3/bin:$ORIGINAL_PATH

2. Download Kernel Sources from
   ftp://ftp.us.kernel.org/pub/linux/kernel/v2.6/
      linux-2.6.13.2.tar.bz2
3. Download patches from www.littlechips.com
   patch-2.6.13.2-ln2410sbc-0.5.gz

4. Install Kernel Source and Patches

# bunzip2 -dc linux-2.6.13.2.tar.bz2 | tar xvf -
# gzip -dc patch-2.6.13.2-ln2410sbc-0.5.gz | (cd linux-2.6.13.2;\
patch -pl)

5. Configure and build kernel

# make xconfig
# make oldconfig
# make clean
# make bootpImage INITRD_PHYS=0x30800000 \
INITRD=/home/aiskac/work/filesystem/last/ramdisk.gz

Steps 1-4 above prepare the necessary GNU GCC toolchain and appropriate kernel version source codes to be cross compiled on the Linux Server.

Step 5 starts by providing kernel customization through an interactive feature selection in the ‘make xconfig’ program. This utility program runs within the X-Windows environment of the Linux Server.

The actual Linux kernel binary is generated upon successful completion of the above ‘make bootpImage . . . ’ command, and will be placed at the following directory:
. . . /linux/arch/arm/boot/bootpImage

Testing of the newly built Linux kernel involves loading and executing the above ‘bootpImage’ file following instruction described earlier.

As described earlier, the bootpImage binary file generated upon a successful build process will contain the kernel image and the associated filesystem, which is required by the kernel.

Step 5 makes an assumption that the filesystem has been built and prepared for the kernel build process. The filesystem in the above command was referred to by the argument:
INITRD=/home/aiskac/work/filesystem/last/ramdisk.gz

The externally built ramdisk.gz contains a filesystem in compressed form. In general, filesystem consists of directory structure, such as /bin, /usr, /dev, etc., which has to be built in an ‘ext2’ file format.

While the /dev directory will be created manually to contain the necessary devices to be supported, eg. /dev/tty0, other Linux commands such as ‘ls’ will originate in a command interface module called ‘Busybox’.

The following section will describe the necessary structure of the filesystem, and the contents of the directories.

Structure of a Filesystem

In a nutshell, a Linux filesystem to be incorporated in the kernel build is simply a compressed form of a directory structure, that is built in an ext2 file format. The steps to convert a directory structure into an appropriate compressed ‘ramdisk.gz’ file will be covered in shortly.

A filesystem working directory can be created, eg. /home/aiskac/work/filesystem/last/rd.

This directory will become the main root directory, from which the filesystem will be built. The following base directories will be created from a root login

# cd /home/aiskac/work/filesystem/last/rd
# mkdir usr
# mkdir bin
# mkdir sbin
# mkdir lib
# mkdir etc
# mkdir dev
# mkdir mnt
# mkdir proc
# mkdir root
# mkdir tmp
# mkdir var

Linux commands that will make up the Linux console interface, eg. ‘ps’ and ‘ls’ commands, will originate in symbolic links to Busybox executable residing within /bin, /sbin, and /usr directories. Contents of these directories will be generated as part of building and installing Busybox, which will be discussed shortly.

The /dev directory will contain the supported device entries, and will be created as follows:

# cd /home/aiskac/work/filesystem/last/rd/dev
# mknod -m 666 tty0 c 4 0
# mknod -m 666 tty1 c 4 1
# mknod -m 666 tty2 c 4 2

...

# mknod -m 666 sda1 b 8 1

...

etc.

In the above example, /dev/tty1 device entry will be created with rw-rw-rw access, character device, major#=4, minor#=1 attributes.

The /mnt directory will be dedicated for device mounting purposes. To support devices such as memory cards and NFS drive to be mounted, the following mounting points will be created:

# cd /home/aiskac/work/filesystem/last/rd/mnt
# mkdir cf
# mkdir nfs
# mkdir sd
# mkdir sm
# mkdir usb
# mkdir loop

The /proc directory is a special directory that will be filled in by the kernel at runtime. It will contain realtime information about the processor, memory, devices, processes, drivers, etc.

To start with, the /etc directory can be copied from the server, and customized as needed. Within /etc directory, an init.d directory can be created to contain two initialization script files: rc.local and rcS.

# cd /home/aiskac/work/filesystem/last/rd/etc
# mkdir init.d
# cd init.d
# vi rcS
# vi rc.local

### EXAMPLES

Content of rcS file:

#!/bin/ash
exec /etc/init.d/rc.local

Content of rc.local file:

#!/bin/ash
hostname -F /etc/HOSTNAME
/bin/date

A file called .profile will be executed at the end of the kernel bootup process. It has to reside at the base of the filesystem directory structure.

# cd /home/aiskac/work/filesystem/last/rd
# vi .profile

Example Content of the .profile:

export PATH=“/:/bin:/sbin:/usr/bin:/usr/sbin:/home/aiskac/work”
umask 022
mount -t proc /proc /proc
ifconfig eth0 192.168.0.110
mount -t usbfs none /proc/bus/usb
mount -t devpts devpts /dev/pts
chown root.root /bin/busybox
chmod 4755 /bin/busybox
/bin/ash

At this point, with the exception of /bin, /sbin, and /usr all the other filesystem directories have been prepared. Building and installing Busybox to the directory structure will complete the filesystem directories.

Building Busybox 1.00

‘Busybox’ is an application program that provides a console interface or shell to the Linux command set. It is a stand-alone module that is called from the kernel in its last bootup stage (through/sbin/init).

Busybox implements tiny versions of common UNIX utilities, such as ls, ps, ifconfig, etc. When those utilities are called, busybox program is invoked through a soft link with the particular command as parameter of the busybox.

Building busybox involves cross compiling the source codes, and creating the softlinks to be placed to the appropriate filesystem directories.

The following steps are taken to build busybox 1.00:
1. Download Busybox source codes from www.busybox.net
   Save downloaded file to: /home/aiskac/work/Busybox
2. Untar the downloaded file
   # tar xzvf busybox-1.00.tar.gz

3. Configure the busybox by selecting the necessary features

# cd /home/aiskac/work/Busybox/busybox-1.00
# make menuconfig
# make oldconfig
# make dep

4. Build busybox
   # make busybox
5. Install busybox to the filesystem directories
   # make PREFIX=/home/aiskac/work/filesystem/last/rd install

In the make menuconfig step, a cross toolchain is selected. Busybox 1.00 utilizes GNU GCC version 2.95.3.

The busybox executable and all the softlinks are copied within /bin, /sbin, and /usr to the filesystem directories. A linuxrc softlink is also copied to the filesystem base directory.

The completed filesystem directory structure is convertible into a rarndisk as will now be described.

Building Ramdisk Filesystem

The regular directory structure is converted into a file that conforms to the ‘ext2’ file format. The file is then compressed using a simple gzip utility, prior to incorporating it to the kernel.

This is accomplished by taking advantage of a Linux ‘mount’ command with a file type specified as ext2:
# mount -t ext2 -o loop /dev/ramfs /mnt/ramdisk

Then, /mnt/ramdisk is filled in with the actual filesystem directories:
# cp -rf /home/aiskac/work/filesystem/last/rd/* /mnt/ramdisk/.

Since /dev/ramfs is mounted in ext2 format, a subsequent unmounting of /mnt/ramdisk places the contents of /mnt/ramdisk back to /dev/ramfs in ext2 file format.
# umount /mnt/ramdisk

Since a filesystem may contain more than 2 Mbytes worth of file, a device for that amount of data is prepared. Furthermore, all commands in this step are performed from the root level.

The following is the script executed for creating the ramdisk filesystem:

#!/bin/sh
umount /mnt/ramdisk
dd if=/dev/zero of=/dev/ramfs bs=1k count=8192
mke2fs -vm0 /dev/ramfs 8192
mount -t ext2 -o loop /dev/ramfs /mnt/ramdisk
cp -rf /home/aiskac/work/filesystem/last/rd/* /mnt/ramdisk
umount /mnt/ramdisk
dd if=/dev/ramfs of=ramdisk bs=1k count=8192
gzip ramdisk

At the successful completion of this script, a ramdisk.gz is generated. This is a compressed filesystem incorporated in the kernel.

The filesystem is uncompressed by the kernel at boot time, and loaded to memory starting at physical address 0x30800000. At that point, it is mounted as a read/write filesystem.

Mounting Devices Under Linux

Hardware modules and devices in Linux environment are treated like files. Assuming the device is enabled and supported by a corresponding device driver in the kernel, it can be accessed by an application program after it has been mounted to the system at run-time.

An example is a USB memory stick, which is inserted to the USB host port of the development board. It will be recognized by the kernel as /dev/sdal. To use this device in the system, it is mounted as follows:
#mount -t vfat /dev/sdal /mount/usb

Other devices may not reflect real hardware modules in the system. Instead, it is an abstraction of devices, such as /proc. This type of device is mounted at boot time to support other system utilities to function properly.

| | |
|---|---|
| #mount -t proc /proc /proc | ;mounting /proc filesystem |
| #mount -t usbdevfs none /proc/bus/usb | ;allows usb devices to be |
| | ;mounted |

Mounting NFS Drive into the Target Board

A user working directory in the Linux Server is mounted to the development board filesystem and appears as a local directory to the development board.

To achieve this, the working directory is setup as an NFS mountable directory, and an NFS deamon started in the Linux Server.

On the development side, the following command will have to be executed successfully:

# mount -t nfs -o nolock 192.168.0.104:/home/aiskac/work /mnt/nfs
# cd /mnt/nfs
# ls

At this point, files on remote server (192.168.0.104) directory become accessible from the local development board. Since the user usually logs in as root into the development board, this poses a great danger by allowing an inadvertent file deletion on the server, from the board side.

With careful understanding of the operations, the nfs remote filesystem mounting capability provides a good mechanism for testing an application program without having to copy the binary executable to the development board directory. An application program will be run directly from the server's directory which has been mounted into the local filesystem.

The same mechanism is applicable for loading and testing device drivers directly from the remote server's directory to the memory of the development board.

Another advantage of this mechanism is the availability of a seemingly unlimited, large amount of read/write disk space for the application program, which is usually unthinkable in a small-scale embedded system. A user application requiring large amount of buffer/file can make use of this method.

Developing Application Software to Run Under Linux

Software modules to support specific product needs may fall into the kernel, device drivers, or application program categories. This section will describe the process for developing application software.

In contrast to the software development in a more traditional embedded system, when designed and implemented correctly, the embedded Linux kernel according to the present invention provides a convenient and very productive method of developing application software.

In this embedded Linux environment, application software can be developed independently of the operating system. The Linux kernel according to the present invention provides the basic context switching mechanism, allowing multiple processes and threads to be run simultaneously within their protected memory spaces.

The kernel also provides devices and device driver supports for the application software, with the capability of loading and unloading the drivers at runtime. Furthermore, the kernel provides the environment for interprocess communication, concurrency device access locking mechanism, signaling methods, etc.

In general, an embedded Linux application program can be written, built, and linked with the library provided by the kernel, to become an executable file. The library may contain simple functions such as Input/Output to the console, or more complicated networking socket APIs.

All throughout the application software development phase, there should be no need to incorporate the kernel and the application module into one binary image. This can be done at the completion of the product development, where the application will have been fully tested, and every module (kernel, drivers, and application) will have to be programmed into a Flash chip.

Advantageously, the application software being developed can be tested directly from an NFS mounted drive, described in the previous section.

A project directory structure functions as a generic template for any future product development. It contains separate kernel, application, and utilities directories.

The kernel directory contains a particular version of Linux kernel source to be used for the project, including the filesystem, and ‘busybox’ directories to build the platform software foundation.

The application directory contains software modules to make up an application software, including its Makefile.

The utility directory contains external utility programs that may be needed for the kernel and/or application software development.

Exemplary Software Application

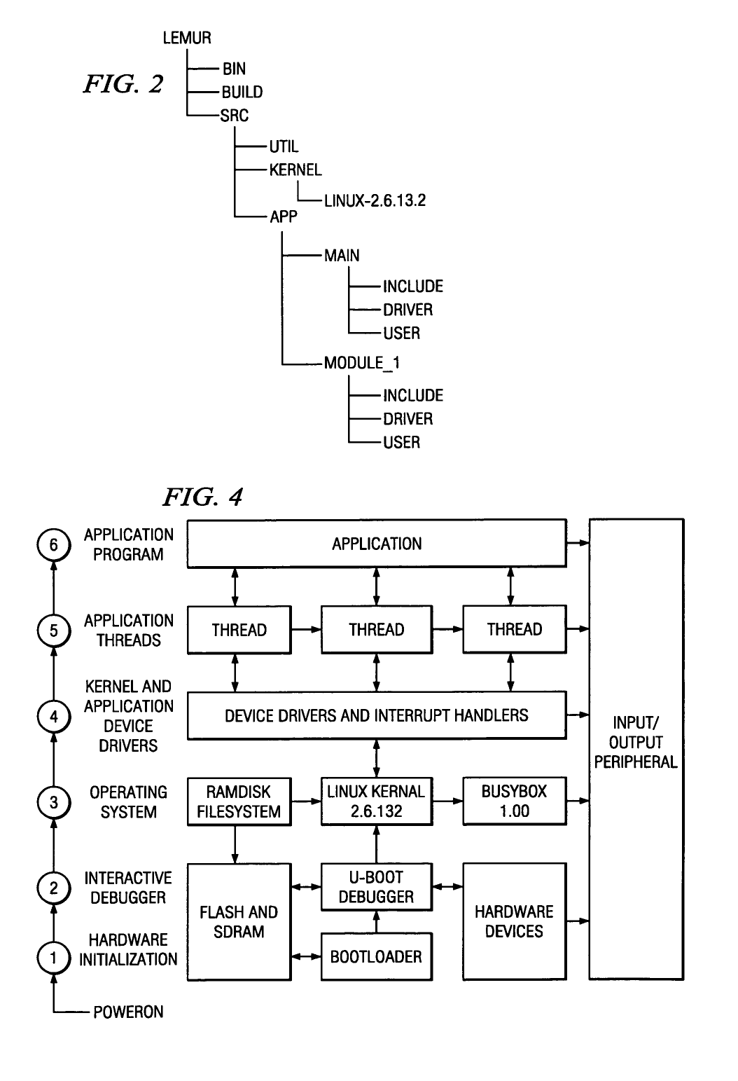

FIG. 2 shows one example of a project directory structure. Within the software module, there is a clean separation between user and driver codes, with the developed application codes residing in the user directory.

The communication between application and driver codes is handled nicely through the include directory.

The following Makefile builds all the .c files within a directory into the corresponding .o files, and for this example, linked into an executable called ‘mainprog’

# Content of a subdirectory Makefile
CC = arm-linux-gcc
CFLAGS = -Wall -O2
INC = -I. -I../include
COMPILE = $(CC) $(CFLAGS) $(INC) -c
HEADER1 = *.h
HEADER2 = ../include/*.h
EXECUTABLE = mainprog
OBJFILES := $(patsubst %.c,%.o,$(wildcard *.c))
all: $(EXECUTABLE)
$(EXECUTABLE) : $(OBJFILES) $(wildcard *.h)

$(CC) -o $(EXECUTABLE) $(OBJFILES)

%.o: %.c $(wildcard $(HEADER1)) $(wildcard $(HEADER2))

$(COMPILE) -o $@ $<

.PHONY : clean
clean:

rm -f $(EXECUTABLE) $(OBJFILES)
@echo “all cleaned up!”

Developing Device Drivers to Run Under Linux

The process of building a device driver is similar to building an application. Some main differences are the compiler flags, which has to include -D_KERNEL_-DMODULE.

In a way, device drivers are built with similar flags as for building the Linux kernel.

Device drivers can use Makefiles as well. At the end of the build process, a testdriver.o will be generated. To allow loading and unloading device driver modules at runtime, the kernel and busybox are configured for module support.

The following Linux commands are used to work on the device driver modules:

# /sbin/insmod -f -o testdriver testdriver.o
# /sbin/lsmod
# /sbin/rmmod testdriver

Software Development Environment

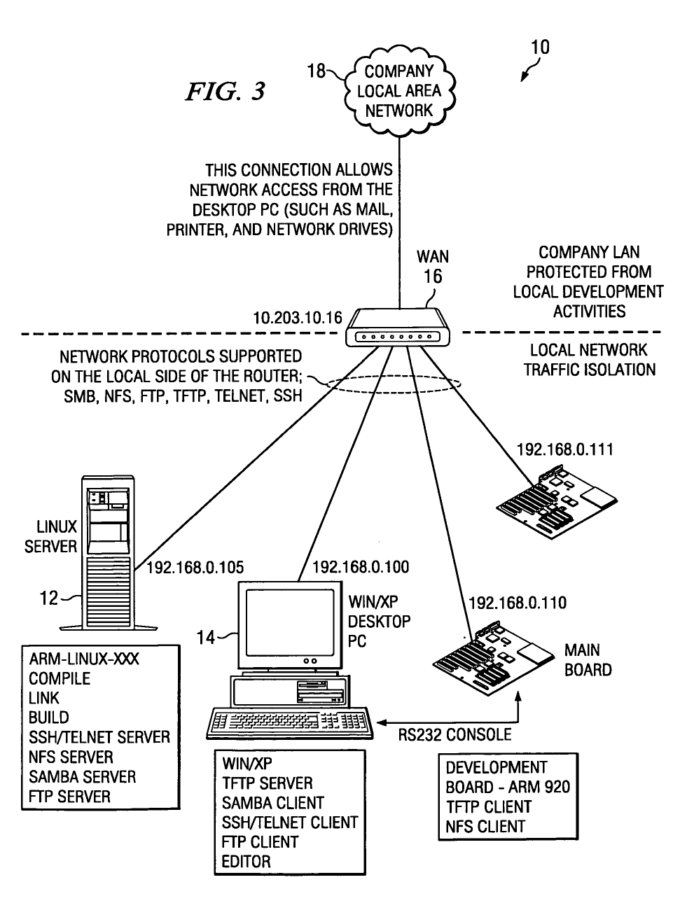

FIG. 3 depicts a software development environment at 10 utilizing the Linux kernel of the present invention.

The build process preferably requires a cross development toolchain to reside on a Linux Server 12 because a GNU based toolchain is free (compared to a Windows hosted toolchain costing more than $5000/seat), robust, and closer to Embedded Linux environment.

The Programmer developing the software may control the development process from his/her Win/XP Desktop PC 14. This is necessary to allow use of more familiar and user friendly Windows utilities, such as visual editor, search tools, file browser, etc., which are not easily available on a Linux based machine.

Since the code development toolchain resides on the Linux Server 12, the user has a work directory on the Linux machine. To allow browsing of the work directory in the Linux Server 12 from the Windows PC 14, a Samba Server/Client protocol is run between the Linux Server and the Windows PC, as shown in FIG. 2, such as via a WAN router 16. Advantageously, this provides a way to map a Linux work directory into Windows Explorer, thus allowing one to work on a Linux file using a more user friendly Windows tools, such as a Windows Visual Editor.

Initiating a code build (compile, link, and code generation) requires a telnet or SSH connection between the Windows PC 14 and Linux Server 12. This allows the programmer to login to the Linux machine and to run a make utility that will build the code. It also provides the programmer a mechanism to work on the Linux Server from his/her Windows PC.

In some cases where a larger size file needs to be transferred between the PC and the Linux Server, a more convenient FTP mechanism is used. Some examples include a backup of the Linux work directory, update of Linux utilities, toolchain, etc. from the PC's internet connection.

The majority of the tasks during the software development process is running and testing the new code (binary or other output format, such as ELF) on the target development.board. To achieve that, the above executable file are transferred from the development machine (Linux Server) to the target board over ethernet connection. The TFTP transport protocol is used between the two nodes. This is usually a continuous activity during the day, with a potential network traffic issue.

A TFTP transfer between two nodes, requires a TFTP Server to manage the communication with a TFTP Client. While the TFTP Client runs on the development board, the TFTP Server runs on a Windows PC, providing full access to drives on the local Windows PC (for loading and testing example binaries), as well as working directories on the Linux Server (for loading and testing development codes).

As the code development effort progresses, an operating system may be introduced to run on the development board, such as an Embedded Linux Kernel. To support a productive embedded Linux software development on the development board, a capability is provided to NFS Mount a drive residing in the Linux Server onto the filesystem of the Linux kernel of the development board. To facilitate the need, an NFS Server can be run on the Linux Server, communicating with the NFS Client on the development board over the local ethernet connection.

Network Architecture Approach

Still referring to FIG. 3 to support the communication method and network protocol required for an efficient and productive software development efforts, and to make sure that all software engineering network activities do not interfere with the company's Local Area Network functionality, the simple router 16 is used. This firewall mainly has the purpose of isolating the local engineering network of computers, servers, and prototype boards from the company's LAN shown at 18.

On the company's side, the router 16 acquires one IP address from the company's DHCP Server, just like a normal Windows desktop PC does.

The router's DHCP Server capability does not show up on the WAN or company's LAN side. Instead, it is used by the computers, servers, and development boards on the router's local side.

The WAN connection from the router 16 to the company's LAN 18 provides normal access to company's email, network drives, printers, and internet.

Initialization and Operation Flowchart

FIG. 4 shows all the software modules described in section 4 and their sequences of invocation. They are depicted on the left side of the figure by upward pointing arrows, starting from the ‘POWERON’ state. FIG. 3 also depicts all the hardware and software building blocks adapted to implement application programs.

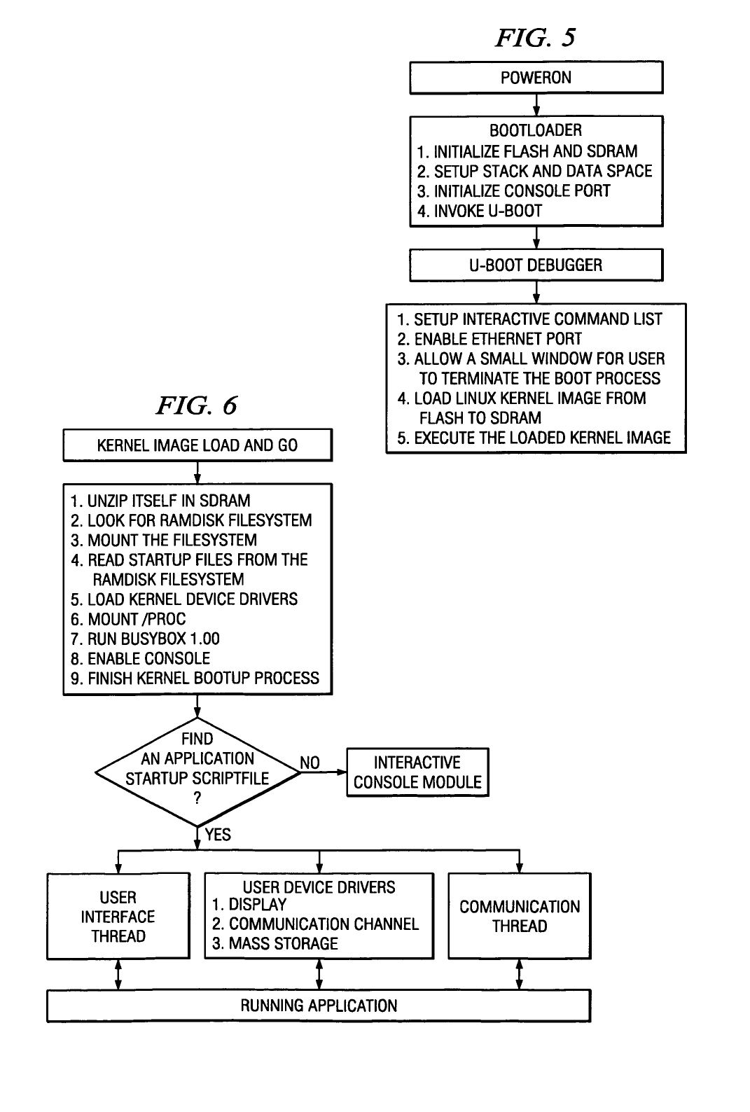

FIG. 5 shown the low-level hardware initialization process in more detail, while FIG. 6 illustrates the flow and steps for loading the operating system which is needed for executing the user application. The user application is composed of two threads, the user interface thread and the communication thread. Along with the threads are the device drivers (display, communication, and mass storage device drivers) that are loaded by the startup script at run-time.

In summary, a solid ARM9 based development platform is provided that advantageously is capable of running embedded Linux kernel, with all of its peripheral devices accessible from the Linux side. The hardware advantageously allows a USB interface to access variety of memory cards (SD, CF, Smart Media, and Memory Stick).

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A software development network, comprising:
at least one Windows based software development system having Windows utilities configured to build source codes;
a communication link; and
a Linux Machine configured to build binary files from the source codes provided via the communication link.

2. The network specified in claim 1 wherein the software development network comprises a local area network.

3. The network specified in claim 1 wherein the communication link further comprises a router.

4. The network specified in claim 3 comprising a plurality of the Windows based software development systems each operatively coupled to provide respective source codes to the Linux Machine.

5. The network specified in claim 1 wherein the Linux Machine includes a toolchain configured to be shared with the at least one Windows based software development system.

6. The network specified in claim 3 wherein development codes residing on the Linux Machine are configured to be selectively loaded to the plurality of Windows based software development systems.

7. The network specified in claim 6 wherein the development codes are configured to be loaded to the plurality of Windows based software development systems independently.

8. The network specified in claim 1 wherein the binary files comprise binary images.

9. The network specified in claim 1 wherein the communication link comprises an Ethernet interface.

10. The network specified in claim 1 wherein the binary files are executable on an ARM processor.

11. A method of creating binary files over a network, comprising the steps of:
a) creating source codes on at least one Windows based software development system using Windows utilities;
b) communicating the source codes to a Linux Machine; and
c) the Linux machine compiling the source codes to create binary files.

12. The method as specified in claim 11 wherein the Linux Machine has a toolchain which is configured to be shared with the Windows based software development system.

13. The method as specified in claim 12 wherein the source codes are communicated via an Ethernet interface.

14. The method as specified in claim 12 wherein the source codes are communicated via a router.

15. The method as specified in claim 11 wherein the source codes are created on a plurality of said Windows based software development systems and then communication to a common said Linux Machine.

16. The method as specified in claim 11 wherein the Linux Machine comprises a toolchain that is shared with the at least one Windows based software development systems.

17. The method as specified in claim 15 wherein the Linux Machine comprises development codes that are selectively loaded to the plurality of Windows based software development systems.

18. The method as specified in claim 17 wherein the development codes are independently loaded to the plurality of Windows based software development systems.

19. The method as specified in claim 11 wherein the binary files are executable on an ARM processor.

20. The method as specified in claim 11 wherein the binary files comprise binary images.
